(19) United States
(12) Patent Application Publication
(10) Pub. No.: US 2024/0370744 A1
(43) Pub. Date: Nov. 7, 2024

(54) REAL-TIME QUALITY PREDICTION SYSTEM

(71) Applicants: National Chengchi University, Taipei City (TW); Dinkle Enterprise Co., Ltd, New Taipei City (TW)

(72) Inventors: MING-SHIOW LO, Taipei City (TW); FANG YU, Taipei City (TW); SHU-CHI LIN, Taichung City (TW)

(21) Appl. No.: 18/653,132

(22) Filed: May 2, 2024

(30) Foreign Application Priority Data
May 2, 2023 (TW) 112116291

(51) Int. Cl. G06N 5/022

(52) U.S. Cl. CPC G06N 5/022

(57) ABSTRACT

A real-time quality prediction system is disclosed, including an input device, a storage device, a processing device, and an output device. The storage device stores real-time machine status data, product specification measurement data, and algorithms. The processing device accesses the storage device to build up a quality prediction model. The quality prediction model includes a data preprocessing module and a model building module. The data preprocessing module provides a pairing procedure to form an input dataset. The model building module builds a hybrid model framework. The hybrid model framework includes setting up a minimax rule and an outbound rule and using a bidirectional long short term memory network. The input dataset is processed by the hybrid model framework to generate output data, which is outputted from the output device to define the accuracy rate.

### CROSS-REFERENCE TO RELATED APPLICATION

This application claims priority from Taiwan Patent Application No. 112116291, filed on May 2, 2023, in the Taiwan Intellectual Property Office, the content of which is hereby incorporated by reference in its entirety for all purposes.

### BACKGROUND OF THE INVENTION

### 1. Field of the Invention

The present disclosure relates to a real-time quality prediction system, particularly to a real-time quality prediction system that provides a high accuracy rate of prediction by combining a hybrid prediction model with set rules and neural networks.

### 2. Description of the Related Art

The global manufacturing industry is rapidly developing towards big data and intelligence, and the intelligent transformation of the manufacturing industry has a great impact on the competitiveness of the industry. The existing manufacturing industry can effectively enhance its productivity through automated equipment for manufacturing; however, it is not possible to have the real-time quality status in control, not to mention reducing the labor cost and time consumed by quality control. After the entire batch has been manufactured, a sampling inspection is done to confirm whether there are any defects or defective products. As a result, not only is it easy to incur the cost of defective products in the whole batch, but also the quality level of the overall product may be reduced.

In the process of intelligent transformation, the introduction of artificial intelligence technology to assist enterprises in process reengineering is the main direction of efforts to enhance the competitiveness of enterprise production. For the whole process of production and machine, the defective products generated by the aforementioned production process are important targets to eliminate the cost of waste in the process and improve the production yield. If the status of the machine and the product can be monitored in the production process and an early warning of product defects can be provided before the occurrence of defects, the cost of waste can be effectively reduced in the workflow, and the production process can also be improved by making appropriate adjustments, making the specifications of the final products produced meet the inspection criteria and improve the product yield rate.

In this view, the existing quality inspection methods make it difficult to ensure the cost of waste generated during the manufacturing process, and also difficult to improve the production yield. In this regard, the inventor of the present disclosure has designed a real-time quality prediction system to tackle deficiencies in the prior art and further enhance the implementation and application in industries.

### SUMMARY OF THE INVENTION

Given the aforementioned conventional technical problems, the purpose of the present disclosure is to provide a real-time quality prediction system to solve the difficulty of detecting product specification defects in real-time by traditional quality inspection, resulting in excessive production of defective products and a waste of production costs.

According to one purpose of the present disclosure, a real-time quality prediction system is provided, including an input device, a storage device, a processing device, and an output device. Wherein, the input device is connected to a production machine and a measuring machine and receives real-time machine status data of the production machine and product specification measurement data of the measuring machine. The storage device is connected to the input device, and the storage device stores the real-time machine status data, the product specification measurement data, and a plurality of algorithms. The processing device is connected to the storage device, and the processing device executes a plurality of control commands to access the storage device to establish a quality prediction model. The quality prediction model includes a data preprocessing module and a model building module. The data preprocessing module matches the real-time machine status data with the product specification measurement data to form an input dataset. The model building module builds a hybrid model framework by using a plurality of algorithms. The hybrid model framework includes a rule encoder and a bidirectional long short term memory network. The rule encoder sets a minimax rule and an outbound rule and encodes the input dataset, which is inputted into the bidirectional long short term memory network to generate output data. The output device is connected to the processing device and the storage device and outputs the output data to define an accuracy rate of the hybrid quality prediction model.

Preferably, the production machine may include a stamping machine, and the measuring machine may include a transient detector.

Preferably, the real-time machine status data may include dataset numbering, machine rotation speed, machine status, and number of stamping per second.

Preferably, the product specification measurement data may include dataset numbering, inspection time, and specification measurement value.

Preferably, from the real-time machine status data and the product specification measurement data with same dataset numbering, the data preprocessing module sets default time difference between inspection time of the measuring machine and production time of the production machine and selects the real-time machine status data with a smallest difference from the default time difference to conduct matching for forming the input dataset.

Preferably, the data preprocessing module may continuously extract multiple periods of the real-time machine status data from a time point with the smallest difference from the default time difference by a bootstrap aggregating method to generate a subset of the input dataset.

Preferably, the minimax rule may determine whether a maximum value of predicted specification is greater than a minimum value of the predicted specification every time, and if not, a first loss value is generated through a minimax value loss function.

Preferably, the outbound rule may determine whether an actual value and a predicted value of each specification fall within a minimax standard, and if not, a second loss value is generated through an outbound rule loss function.

Preferably, the first loss value may include a first weight, the second loss value may include a second weight, the first weight ranges from 0 to 0.4, and the second weight ranges from 0 to 0.6.

Preferably, the first weight by default is set to 0.1 and the second weight by default is set to 0.1.

As mentioned above, the real-time quality prediction system of the present disclosure may have one or more following advantages:

(1) This real-time quality prediction system may predict product specifications according to the real-time machine status data of production machines by establishing a quality prediction model, so that the production status of the product may be monitored in real-time during the production process. When the product specifications exceed the set rules, an immediate warning will be issued to adjust the machines in production to avoid scrapping the entire batch of defective products and increasing production costs.

(2) This real-time quality prediction system may establish a quality prediction model based on real-time status data and measurement specification data by combining restriction rules and a bidirectional long short term memory network. By adjusting the weight of the restriction rules to improve the accuracy rate of the quality prediction model.

(3) The real-time quality prediction system may discover product specification defects early through the quality prediction model, reduce the problem of defective products in the production of final products, improve the overall production yield, and reduce waste costs in the manufacturing process, thus improving corporate profits and competitiveness.

### BRIEF DESCRIPTION OF THE DRAWINGS

To make the technical features, content, and advantages of the present disclosure and the achievable effects more obvious, the present disclosure is described in detail together with the drawings and in the form of expressions of the embodiments as follows:

FIG. 1 is a block diagram of the real-time quality prediction system according to an embodiment of the present disclosure.

FIG. 2 is a systematic architectural diagram of the data preprocessing module according to an embodiment of the present disclosure.

FIG. 3 is a systematic architectural diagram of the model building module according to an embodiment of the present disclosure.

FIG. 4 is a result-predicting schematic diagram of rule weight adjustment according to the embodiment of the present disclosure.

### DESCRIPTION OF THE PREFERRED EMBODIMENTS

To illustrate the technical features, contents, advantages, and achievable effects of the present disclosure, the embodiments together with the accompanying drawings are described in detail as follows. However, the drawings are used only to indicate and support the specification, which is not necessarily the real proportion and precise configuration after the implementation of the present disclosure. Therefore, the relations of the proportion and configuration of the accompanying drawings should not be interpreted to limit the actual scope of implementation of the present disclosure.

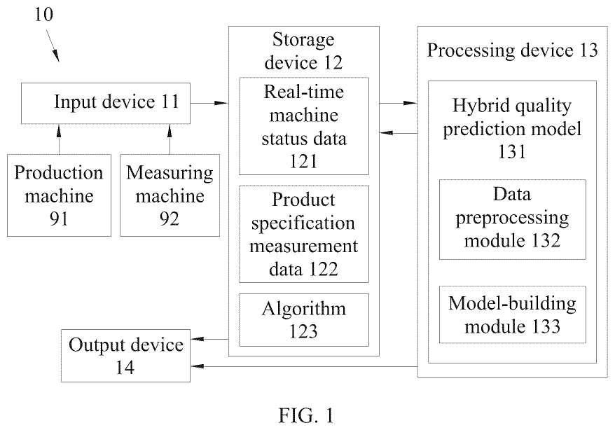

Please refer to FIG. 1, which is a block diagram of the real-time quality prediction system according to an embodiment of the present disclosure. As shown in the figure, the real-time quality prediction system 10 includes an input device 11, a storage device 12, a processing device 13, and an output device 14. The input device 11 is connected to a production machine 91 and a measuring machine 92. Real-time machine status data 121 of the production machine 91 and product specification measurement data 122 of the measuring machine 92 are transmitted to the storage device 12 through the input device 11. The input device 11 may be a data collector, which is installed on the production machine 91 and the measuring machine 92 to monitor the production status of the production machine 91 and the detection status of the measuring machine 92. In other embodiments, the input device 11 may be a data transmission interface connected to the production machine 91 and the measuring machine 92, and the detection data of the machine is transmitted to the storage device 12 through the data transmission interface.

The storage device 12 is connected to the input device 11 and stores real-time machine status data 121, product specification measurement data 122, and a plurality of algorithms 123. The storage device 12 may be storage media such as a read-only memory, a flash memory, a disk, or a cloud database of a computer device, or may be a server or a database of a cloud device. When the real-time machine status data 121 and product specification measurement data 122 are received from the input device 11, these data may be stored in the storage device 12 for follow-up analysis, and various analytic algorithm programs are also stored in the storage device 12. The processing device 13 is connected to the storage device 12, and the processing device 13 includes a central processing unit, a microprocessor, an image computing processor, etc., in a computer or server device. The processing device 13 may execute control commands to access data in the storage device 12 and establish a hybrid quality prediction model 131 by executing algorithms and analytic programs.

The hybrid quality prediction model 131 includes a data preprocessing module 132 and a model building module 133. The data preprocessing module 132 matches the real-time machine status data 121 with the product specification measurement data 122 to form an input dataset. The model building module 133 builds a hybrid model framework using a plurality of algorithms 123. The hybrid model framework includes a rule encoder and a bidirectional long short term memory network. The rule encoder sets a minimax rule and an outbound rule and encodes the input dataset, which is inputted into the bidirectional long short term memory network to generate output data. The output device 14 is connected to the processing device 13 and the storage device 12 and outputs the output data to define an accuracy rate of the hybrid quality prediction model 131. The contents of the data preprocessing module 132 and the model building module 133 are to be described below with embodiments.

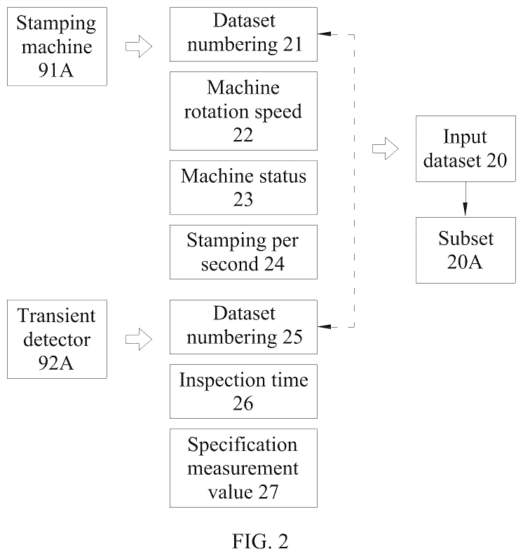

Please refer to FIG. 2, which is a systematic architectural diagram of the data preprocessing module according to an embodiment of the present disclosure. As shown in the previous embodiment, the real-time machine status data 121 and product specification measurement data 122 of the production machine 91 and the measuring machine 92 respectively represent the production status of the production machine 91 and the relevant specifications of the final product inspected by the measuring machine 92. The conventional quality management, which is considered inefficient, mainly involves having the specifications of final products inspected by machines or workers after the machines finish the entire batch of products. When the defective rate is high, several final products would be eliminated, causing a lot of cost losses. If product quality can be monitored in real-time during the production process, predictions may be made and production line personnel may be reminded to make corrections before defective products occur. Not only may the waste of scrap products be reduced, but also production quality and yield may be improved effectively. As shown in the figure, the stamping machine 91A is taken as an example for the production machine 91, while the transient detector 92A is taken as an example for the measuring machine 92 to replace the manual inspection method. By monitoring the data of the stamping machine 91A and the transient detector 92A in real-time, real-time quality prediction is performed to achieve the effect of real-time monitoring and management.

In the present embodiment, the real-time machine status data 121 of the stamping machine 91A includes dataset numbering 21, machine rotation speed 22, machine status 23, and number of stamping per second 24. The product specification measurement data 122 of the transient detector 92A includes dataset numbering 25, inspection time 26, and specification measurement value 27. The dataset numbering 21 of the real-time machine status data 121 includes stamping time (inspection of setup time of work order), machine numbering, and work order numbering of the stamping machine 91A. The dataset numbering 25 of the corresponding product specification measurement data 122 includes inspection time (inspection of setup time of work order), machine numbering, and work order numbering of the transient detector 92A. The machine rotation speed 22 refers to the operation speed of the machine motor, the machine status 23 includes status types such as shutdown, standby, normal operation, and manual adjustment, and the number of stamping per second 24 is the number of stamping per second by the machine. The specification measurement value 27 is the maximum value and minimum value of each specification measured in the sampling inspection results during product sampling.

By pairing data with the same dataset numbering (21 and 25), the input dataset 20 of real-time machine status data 121 and product specification measurement data 122 is formed, which is then used as training data for the network model. In the present embodiment, from the real-time machine status data 121 and the product specification measurement data 122 with the same dataset numbering (21 and 25), the data preprocessing module 132 sets default time differences between the inspection time of the transient detector 92A and the production time of the stamping machine 91A and selects the real-time machine status data 121 with the smallest difference from the default time difference to conduct the matching for forming the input dataset 20. For example, if the difference between stamping production and inspection time is approximately one hour, the default time difference may be set to one hour. The real-time machine status data 121 one hour before the detection time point is selected to pair with the product specification measurement data 122 to form the input dataset 20.

In another embodiment, the data preprocessing module 132 may extract samples from the training data by utilizing the bootstrap aggregating method in the manner of sampling with replacement. That is, in addition to the aforementioned paired time point data, multiple periods of real-time machine status data 121 are continuously extracted from a time point with the smallest difference from the default time difference to generate a subset 20A of the input dataset 20 as model training data. The input dataset 20 may be divided into training data and test data according to a predetermined ratio, such as a 7:3 ratio. During training, the training data may be divided again and the training performance may be evaluated in the cross-validation method.

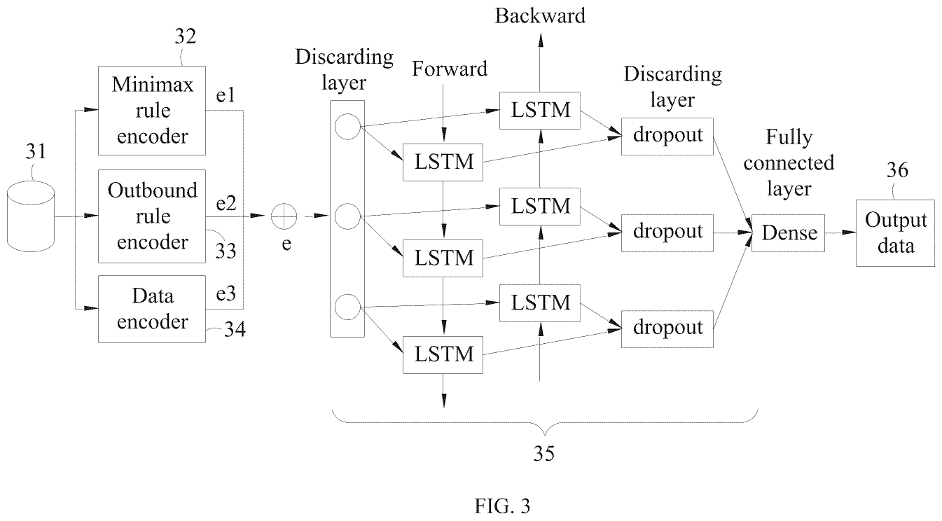

Please refer to FIG. 3, which is a systematic architectural diagram of the model building module according to an embodiment of the present disclosure. As shown in the figure, after obtaining the input dataset 31, the model building module 133 builds a hybrid model framework using a plurality of algorithms 123. The hybrid model framework includes a rule encoder. The rule encoder includes a minimax rule encoder 32, an outbound rule encoder 33, and a data encoder 34. In combination with the three encoders, characteristic values of hidden layers in neural networks are extracted respectively. The data encoder 34 refers to predicting product specifications, whose objective function is the discrepancy between predicted product rules and actual measurement specifications. This discrepancy is expressed as the residual e3 of the loss function. In the present embodiment, the loss function of the data encoder 34 may be expressed as the mean square value of the difference between the predicted value and the actual value, as shown in Equation (1).

$${L}_{Task} = MSE ( y , \hat{y} ) \qquad ( 1 )$$

Specifically, y is actual value and ŷ is predicted value.

In the present embodiment, in addition to the residual between the actual value and the predicted value, the logical control rule of the minimax rule and the outbound rule is also added to improve the accuracy of the overall prediction. In the minimax rule encoder 32, whether the maximum value of predicted specification is greater than the minimum value of the predicted specification is determined every time, and if not (the maximum predicted specification is less than the minimum predicted specification), the minimax rule encoder 32 generates the first loss value e1 through the minimax value loss function. The minimax value loss function of the minimax rule encoder 32 may be expressed by Equation (2).

$${L}_{minmax rule} = {\sum }_{i = n , j = 0}^{2 n - 1 , n - 1} floor ( \hat{y} [ : , i ] \div \hat{y} [ : , j ] ) \qquad ( 2 )$$

Specifically, i is the min value of the predicted specification, j is the max value of the predicted specification, and n is the number of predicted specifications. The predicted minimum value is divided by the maximum value, whose result is then unconditionally rounded up. If the predicted minimum value is greater than the maximum value, 1 is sent back, and finally the results of all specifications are added to become the first loss value e1.

In the outbound rule encoder 33, whether the actual value and the predicted value of each specification fall within the minimax standard is determined, and if not (the actual value of the specification meets the standard, but the predicted value of the specification does not; the actual value of the specification does not meet the standard, but the predicted value of the specification does), the second loss value e2 is generated through an outbound rule loss function. The outbound rule loss function of the outbound rule encoder 33 may be expressed by Equation (3).

$${L}_{outbound rule} = {\sum }_{i = 0}^{2 n - 1} \vert floor ( y [ : , i ] \div std ( i ) ) - floor ( \hat{y} [ : , i ] \div std ( i ) ) \vert \qquad ( 3 )$$

Specifically, n is the predicted specification number, std is the minimax range of the specification. First, the actual value and the predicted value are divided by the boundary of the specification, whose result is then unconditionally rounded up. The values greater than the specification range are converted to 1, and the values smaller than the specification range are converted to 0. Finally, the absolute value is obtained by subtracting the two converted values representing the actual value and the predicted value. If the two values are the same, the second loss value e2 is 0; on the contrary, if the two values are different, the second loss value e2 is 1.

Finally, the weights are adjusted during model training by combining the three loss functions. The first loss value may include a first weight, the second loss value may include a second weight, and the residual e between the predicted value and the true value is calculated, which is represented by Equation (4).

$${L}_{Total} = α * {L}_{minmax rule} + β * {L}_{outbound rule} + ( 1 - α - β ) * {L}_{Task} ( α ∈ [ 0 , 1 ] , β ∈ [ 0 , 1 ] ∧ ( α + β ) \leq 1. ) \qquad ( 4 )$$

α is the first weight, and β is the second weight. The first weight may range from 0 to 0.4, and the second weight may range from 0 to 0.6. In other embodiments, the first weight by default may be set to 0.1 and the second weight by default may be set to 0.1.

The aforementioned data are inputted into the bidirectional long short term memory network 35, and the bidirectional long short term memory network 35 includes an input layer. Through a plurality of input nodes, the data enters the forward and backward long short term memory network (LSTM). Then, after the operations of the discarding layer and the fully connected layer, the final output data 36 is outputted. The maximum and minimum predicted values of the model output are determined for size specification. If the maximum predicted value or minimum predicted value of a size code exceeds the upper and lower bounds of the size specification, it is considered a defective product and marked as 0; in contrast, if all meet the specifications, it is considered a non-defective product and marked as 1. The same method is also used for the real value to determine whether it meets the specifications, which is marked as the basis for the calculation of the accuracy rate.

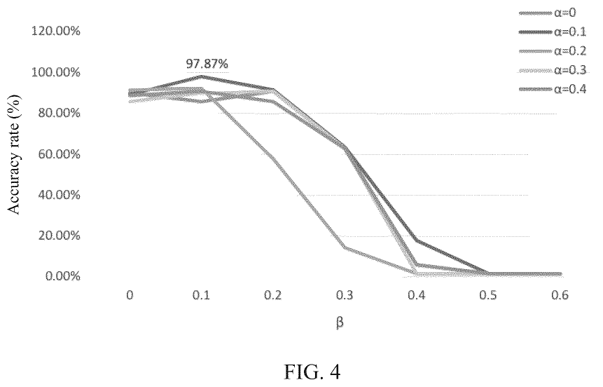

Refer to FIG. 4, which is a result-predicting schematic diagram of rule weight adjustment according to the embodiment of the present disclosure. After being encoded by the rule encoder, the input dataset is entered into the bidirectional long short term memory network and finally outputted. The hybrid quality prediction model may validate the accuracy of the prediction through the calculation of the accuracy rate as shown below.

Accuracy rate=(the number of actual non-defective products and predicted non-defective products+the number of actual defective products and predicted defective products)/the total number

The accuracy rate of non-defective products=The number of actual non-defective products and the predicted number of non-defective products/the number of actual non-defective products

The accuracy rate of defective products=the number of actual defective products and the predicted number of defective products/the number of actual defective products

In the present embodiment, by adjusting the weights, the accuracy rate of the hybrid quality prediction model is analyzed. As shown in the figure, the first weight of the first loss value may range from 0 to 0.4, and the second weight of the second loss value may range from 0 to 0.6. The accuracy rate of the first weight and the second weight is shown in Table 1 below.

TABLE 1

| | β | | | | | | |
|---|---|---|---|---|---|---|---|
| α | 0.0 | 0.1 | 0.2 | 0.3 | 0.4 | 0.5 | 0.6 |
| 0.0 | 89.93% | 85.61% | 90.65% | 62.59% | 5.76% | 1.42% | 1.42% |
| 0.1 | 89.21% | 97.87% | 91.36% | 63.31% | 17.73% | 1.42% | 1.42% |
| 0.2 | 91.37% | 92.19% | 57.55% | 14.18% | 1.42% | 1.42% | 1.42% |
| 0.3 | 85.61% | 89.93% | 90.65% | 62.59% | 1.42% | 1.42% | 1.42% |
| 0.4 | 88.49% | 90.65% | 85.61% | 62.59% | 5.76% | 1.42% | 1.42% |

From the values of the aforementioned accuracy rate, a schematic curve diagram as shown in FIG. 4 may be drawn. As shown in the figure, when the first weight and the second weight are both 0, the accuracy rate of the hybrid quality prediction model is approximately 90%. However, when the first weight is 0.1 and the second weight is 0.1, the accuracy rate of the hybrid quality prediction model rises to 97.89%, significantly improving the predicted accuracy rate, which means that the prediction results are quite close to the actual results. Nevertheless, when the second weight exceeds 0.3, the accuracy rate decreases significantly, which indicates that giving too much weight to the restriction rules will reduce the predicted accuracy rate. In the present embodiment, when the first weight is 0.1 and the second weight is 0.1, the hybrid quality prediction model has the highest accuracy rate. However, the present disclosure is not limited thereto. Based on the limitations of different production types, models, machines, etc., the weights may be adjusted according to actual conditions, so that the hybrid quality prediction model may achieve the best predicted effect.

The above description is merely illustrative rather than restrictive. Any equivalent modifications or alterations without departing from the spirit and scope of the present disclosure are intended to be included in the following claims.

What is claimed is:

1. A real-time quality prediction system, comprising:
an input device, connected to a production machine and a measuring machine, and receiving real-time machine status data of the production machine and product specification measurement data of the measuring machine;
a storage device, connected to the input device, and the storage device storing the real-time machine status data, the product specification measurement data, and a plurality of algorithms;
a processing device, connected to the storage device, the processing device executing a plurality of control commands to access the storage device to establish a quality prediction model, and the quality prediction model comprising following modules:
a data preprocessing module, matching the real-time machine status data with the product specification measurement data to form an input dataset; and
a model building module, building a hybrid model framework through the plurality of algorithms, the hybrid model framework comprising a rule encoder and a bidirectional long short term memory network, the rule encoder setting a minimax rule and an outbound rule, and the input dataset being encoded and then inputted into the bidirectional long short term memory network to generate output data; and
an output device, connected to the processing device and the storage device, and outputting the output data to define an accuracy rate of the hybrid quality prediction model.

2. The real-time quality prediction system according to claim 1, wherein the production machine comprises a stamping machine, and the measuring machine comprises a transient detector.

3. The real-time quality prediction system according to claim 2, wherein the real-time machine status data comprises dataset numbering, machine rotation speed, machine status, and number of stamping per second.

4. The real-time quality prediction system according to claim 2, wherein the product specification measurement data comprises dataset numbering, inspection time, and specification measurement value.

5. The real-time quality prediction system according to claim 2, wherein from the real-time machine status data and the product specification measurement data with same dataset numbering, the data preprocessing module sets default time difference between inspection time of the measuring machine and production time of the production machine and selects the real-time machine status data with a smallest difference from the default time difference to conduct matching for forming the input dataset.

6. The real-time quality prediction system according to claim 5, wherein the data preprocessing module continuously extracts multiple periods of the real-time machine status data from a time point with the smallest difference from the default time difference by a bootstrap aggregating method to generate a subset of the input dataset.

7. The real-time quality prediction system according to claim 1, wherein the minimax rule determines whether a maximum value of predicted specification is greater than a minimum value of the predicted specification every time, and if not, a first loss value is generated through a minimax value loss function.

8. The real-time quality prediction system according to claim 7, wherein the outbound rule determines whether an actual value and a predicted value of each specification fall within a minimax standard, and if not, a second loss value is generated through an outbound rule loss function.

9. The real-time quality prediction system according to claim 8, wherein the first loss value comprises a first weight, the second loss value comprises a second weight, the first weight ranges from 0 to 0.4, and the second weight ranges from 0 to 0.6.

10. The real-time quality prediction system according to claim 9, wherein the first weight is 0.1 and the second weight is 0.1.
